(19) United States
(12) Patent Application Publication
(10) Pub. No.: US 2014/0279496 A1
(43) Pub. Date: Sep. 18, 2014

(54) METHOD AND SYSTEM FOR IMPLEMENTING A CO-BUY ORDER CAPTURE MECHANISM

(71) Applicant: ORACLE INTERNATIONAL CORPORATION, Redwood Shores, CA (US)

(72) Inventor: Christian F. RAUH, Atlanta, GA (US)

(73) Assignee: ORACLE INTERNATIONAL CORPORATION, Redwood Shores, CA (US)

(21) Appl. No.: 13/795,592

(22) Filed: Mar. 12, 2013

(51) Int. Cl. G06Q 20/38

(52) U.S. Cl. CPC G06Q 20/388
USPC 705/44

(57) ABSTRACT

Disclosed is an improved approach to implement a shopping interface that includes a co-buy purchase option. The co-buy mechanism permits any purchase decision by a consumer to be implemented as a group purchase. The co-buy mechanism provides functionality to automatically implement sharing of the purchase prices by the participants to the group purchase.

### BACKGROUND AND SUMMARY

The present application relates to software development and more specifically to systems, methods, and patterns for implementing order capture software applications.

Many types of business logic are implemented by software applications. For example, software applications often include business logic to perform price quotations and order capture for customers. For the price quotation business logic, a pricing engine may be implemented to receive input data (e.g., product name or product ID) and to return output data that includes the price for each product in the input data. For the order capture business logic, an order capture engine and/or eligibility engine may be used to receive input data regarding a potential order (e.g., customer ID and product ID) and provide output data regarding the order capture or order eligibility.

There are many vehicles that can be used to present order capture business logic to customers. For example, there are many dedicated online shopping sites on the Internet that allow a customer to browse/search for products, and to then purchase the items directly from the shopping site. Many businesses also provide company-specific shopping sites that permit customers to purchase items directly from the business.

With the increasing popularity of social media websites or portals, such as Facebook®, Twitter®, and other such sites, many marketers and businesses have begun to exploit these channels to market and sell their products and services. These portals provide a platform for individual users to interact, and at the same time present organizations with potential marketing tools, such as Facebook® pages, or Twitter® handles, enabling marketers to interact with social media “followers.” Marketers can post messages or advertisements on these social media systems as a way to advertise outside traditional marketing channels. Members, in turn, can respond by clicking on embedded links, replying to the messages, starting posts based on the messages, or performing other site-specific functions. Further, marketers can embed an organization-specific or marketing campaign-specific URL (webpage address) within the messages, driving users and web traffic to a separate web site.

Increasingly, businesses are starting to provide full-fledged shopping experiences through these social media sites. To accomplish this, the business provides a shopping interface through the social media site that allows the user to search and/or browse through a sales catalog, and to place orders for items as desired. The shopping interface also includes mechanisms to implement payment services so that the customer can make payment to complete the order.

The present disclosure is directed to improved approaches to implement the shopping interface that is electronically presented to users. According to some embodiments of the invention, a co-buy mechanism is implemented that permits a product to be purchased by a group of customers. By doing so, the cost of the item can be shared a plurality customers.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

FIG. 1 shows a flowchart of a process for implementing co-buy according to some embodiments of the invention.

FIG. 2 illustrates an example of an originator path according to some embodiments of the invention.

FIG. 3 illustrates an example of a contributor path according to some embodiments of the invention.

FIG. 4 illustrates an example of an originator management path according to some embodiments of the invention.

FIG. 5 illustrates an example of an approach to implement a system timer according to some embodiments of the invention.

FIGS. 6A-D illustrate example system architectures that may be employed according to embodiments of the invention.

FIG. 7 illustrates an architecture for implementing a shopping application on a social media site according to some embodiments of the invention.

FIG. 8 illustrates an architecture for implementing an administrative module for a shopping application according to some embodiments of the invention.

FIG. 9 illustrates an example system of computing components that may be employed to implement one or more embodiments of the invention.

### DETAILED DESCRIPTION

The present disclosure is directed to improved approaches to implement a shopping interface that is electronically presented to users. According to some embodiments of the invention, a co-buy mechanism is implemented that permits a product to be purchased by a group of customers. By doing so, the cost of the item can be automatically shared by a plurality of customers.

Consider the scenario of a group of friends that seek to collectively purchase an item, e.g., to share the cost of a high-dollar purchase among all the members of the group. Conventional shopping systems do not have the capability to handle this type of purchase. Instead, conventional shopping systems would require one of the purchasers to individually order the item and to individually provide payment upfront to complete the purchase. To obtain any sharing of the costs, the person initially making the purchase would have to bear the onus of seeking recompense from the other individuals within the group. This could be a highly burdensome process that may or may not successfully and sufficiently compensate the original purchaser to the point where he/she incurs no more than a fair share of the costs. In fact, the burdens created by this conventional approach may create enough disincentives to significantly reduce such group purchases of items.

Consider another possible scenario, where an individual has found a gift item on a shopping site for a recipient, e.g., for a birthday or other occasion. The gift, however, is quite expensive and the individual cannot afford to purchase the item by himself. The individual believes that other members of his group would be happy to participate to purchase the item for the intended recipient. The problem is that with conventional systems, there is no automated way for the individual to coordinate this type of group purchase, or to even determine whether or not the other members of the group will agree to collectively purchase the item. Even if the individual uses electronic means to check with the other members of the group, and the other members of the group affirmatively agree to help with the purchase (e.g., by using email, text, or messaging communications), there is no conventional way to force the other members to guarantee their share of the purchase price. In addition, conventional shopping sites do not have the ability to complete sales on the basis of collective contributions, thereby preventing the sale if no individual member of the group has the financial means by himself/herself to place the order.

Embodiments of the present invention provide a co-buy mechanism that addresses these problems with conventional shopping systems. The co-buy mechanism allows multiple members of a group to share in the cost of purchasing an item. Notifications are provided to members of the group, who may either choose to participate or not. Each of the members of the group that choose to participate contributes to payment for the item to complete the purchase.

FIG. 1 shows a flowchart of an approach to implement the invention according to some embodiments of the invention. At 102, a shopping interface is presented to the user with the co-buy option. The shopping interface may be presented in any medium. For example, the shopping interface may be provided on a web browser to display web pages for a company shopping website or a storefront on a social media page.

Various options may be implemented for the co-buy mechanism. These options include identification of other possible participants to invite, relative sharing amounts for the purchase, and/or time periods to wait for responses from invited participants. In one embodiment, the maximum time period option has a threshold that is the extent of a credit card authorization time period. In one embodiment, the time period can be extended, which results in a request or reauthorization of an authorization time period with a credit card company (or other payment company). Another option is to set thresholds for going through with the group purchase, e.g., by setting a minimum number of consumers that agree to participate in the purchase. Other options are also available. For example, presentation settings may be implemented that are directed to the intended recipient, e.g., to include and set the delivery message(s) and to set delivery parameters.

In certain embodiments, the options can be set to allow participants to contribute un-equal amounts if desired and appropriately configured, where the originator sets a fixed amount for contributors and/or allows for flexible amounts to permit contributors to contribute whatever they can. Once all contributors have contributed and the total is or is not sufficient, notifications can be sent out.

The user would select the desired co-buy options and initiate the group purchase. At 104, the instructions to implement the co-buy would be received by the order capture system. Using the co-buy options selected by the user, the co-buy mechanism would, at 106, configure the parameters of the possible purchase. This includes, for example, storing a list of the possible participants in a database, along with an indication of whether or not the invited participant has agreed to participate. In addition, with consideration of the number of participants, the co-buy mechanism would determine the amount to be paid by each participant, e.g., by evenly dividing the purchase amount by the number of participants. The database would be updated as responses are later received from the invited participants.

At 108, the co-buy invitations are sent to the other possible participants. These invitations set forth terms of the possible group buy to the possible participants. The invitation also includes an interface for allowing the invited participant to indicate whether or not a choice is made to participate in the group purchase, e.g., sending a return message and/or by linking to the shopping site. If responding in the affirmative, the participant will also provide payment information. In some embodiments, the invited participants can invite more possible participants, e.g., to further reduce the costs to each member of the group. In an alternate embodiment, the participant can indicate the amount that he/she is willing to contribute regardless of the number of participants, e.g., as either a minimum or maximum amount. In one or more embodiments, the original purchase may reject a later-added participant, e.g., a new participant that is added from an invitee.

A determination is made at 110 whether the configured buying conditions have been satisfied. For example, this action can check whether a threshold number of consumers have agreed to participate, whether the cost to each individual in the group purchase is below a threshold amount, and/or whether the committed amounts by the participants is enough to match the price of the purchase. This action can be made at the end of a designated time period and/or time limit for the purchase.

If the threshold conditions for purchase are met, then the order is finalized at 112. At this point, the payment systems are accessed to complete the payment portion of the group purchase for each participant. A notice can also be sent to the original user and/or to all of the participants indicating the successful purchase and the terms of the purchase.

If the threshold conditions for purchase are not met, then the purchase order is denied at 114. Regardless of whether payment information had already been entered by some of the participants, those payments do not get fulfilled for processing since the sale has been denied. Therefore, prior payment authorizations would be cancelled at this point. A notice can be sent to the original user and/or to all of the participants indicating the failure of the group purchase.

FIG. 2 shows a flowchart of a process flow pertaining to the originator of the group purchase. At 202, the sales process for the originator reaches the point of going to the order checkout. A determination is made at 204 whether the originator wishes to use the co-buy approach to purchase one or more items in his/her shopping cart. If not, then the user continues with a normal and conventional purchase path through the shopping system

If, however, the user chooses the co-buy approach, then co-buy options are selected at 208. For example, one or more of the following co-buy options may be utilized: (a) creating a note if desired; (b) adding/removing contributors; (c) showing an estimate price; (d) showing contributor amounts; and/or (d) configuring a timer.

At 210, shipping/delivery options are selected for the purchase. In addition, payment information for the originator is received, e.g., by obtaining credit card or Paypal information, and/or by linking to an appropriate payment service. The order summary is then generated at 212.

At 214, the shopping system will send notifications to the other possible contributors. The notifications can be in any form, e.g., using email or text messaging. The notifications include adequate information to set forth the terms of the possible purchase, as well as providing a way for the recipients to indicate acceptance or not of the offer.

At 216, the system configures the setting for the end of the co-buy order. For example, a timer (e.g., a 48 hour timer) may be set to indicate the end time period for the offer. The configuration settings may alternatively set other conditions for ending the offer, e.g., when enough acceptances are received to cover the purchase amount or when enough denials are received such that amount for each participant would exceed a threshold dollar amount.

FIG. 3 shows a flowchart of a process flow pertaining to the participant paths for the group purchase. At 302, the participant is presented with an interface corresponding to the possible purchase, e.g., by clicking on an URL in the notification message and/or by clicking to visit the store site. At 304, the participant is presented with the shopping cart page that displays the co-buy information on the page.

A determination is made at 306 whether the participant agrees to accept the terms of the group purchase. This determination is made, for example, by checking whether the user selects the portion/button on the shopping cart interface to accept the purchase conditions. If the participant does not agree, then the co-buy process ends for that participant, and at 308, the interface takes the participant to another portion of the shopping site, e.g., to the shop root page. If the purchase was configured such that each and every participants needs to agree as a condition of the purchase, then 316 is also performed by the shopping system at this point to cancel payment authorizations for other possible purchasers.

If, however, the participant agrees to join in the purchase, then the co-buy options are presented at 310. As noted above, possible examples of such options include one or more of the following: (a) creating a note if desired; (b) adding/removing contributors; (c) showing an estimate price; (d) showing contributor amounts; and/or (d) configuring a timer.

Based upon the selected co-buy options, configurations may occur for the deal. For example, invitations can be made by the system at 318 to include other possible participants for the order. In addition, the price can be adjusted at 320, e.g., when participants are added or removed from the order.

At 312, payment information for the originator is received, e.g., by obtaining credit card or Paypal information, and/or by linking to an appropriate payment service. The order summary is then generated at 314.

At 322, the order status is set for the group purchase, e.g., by accounting for any changes in price and/or participation. A determination is made at 324 whether the order process is complete, e.g., whether all of the invited participants have responded. If so, then at 326, the order is completed and fully captured at this point.

The process then proceeds to 328 to send notification to the contributors. Such notifications include, for example, one or more of the following: (a) notification that someone has contributed; (b) notification of a price change; (c) notification of a need for a payment re-authorization (e.g., credit card re-authorization); (d) a message to indicate completion of the order.

FIG. 4 shows a flowchart of a process flow pertaining to the originator path for managing the group purchase. At 402, the originator is presented with an interface corresponding to management of the order, e.g., by clicking on an URL and/or by clicking to visit the store site.

At 406, an interface is presented to allow the originator to add and/or remove participants from the order. This interface option loops back to 404 as needed or desired. A determination is made at 412 whether this option has been exercised by the originator.

If the originator adds one or more contributors, then at 414, the price can be adjusted for the order. The process then proceeds to 416 to send notification to the contributors. Such notifications include, for example, one or more of the following: (a) notification that someone has contributed; (b) notification of a price change; (c) notification of a need for a payment re-authorization (e.g., credit card re-authorization); (d) a message to indicate completion of the order.

If the originator removes one or more contributors, then at 418 the process proceeds to cancel payment authorizations the removed contributors and/or for all of the contributors. At 420, the timer can then be reset. The price can then be adjusted for the order at 414. The process then proceeds to 416 to send notification to the contributors as discussed above.

If the co-buy option was exercised to cancel the order, then the order is cancelled at 408. At 422, the process proceeds to cancel all payment authorizations for the contributors. The order status is set at 424 to indicate cancellation of the order. At 426, notification is sent to all contributors of the order cancellation. The order summary is also updated and presented at 410.

FIG. 5 shows a flowchart for operation of a system timer according to some embodiments of the invention. At 502, the process loops through a process to check (at 504) for whether the order has expired. This can be performed, for example, every n seconds. The process determines at 506 whether the timer has expired. If not, then the process returns back to 502.

If the process has expired, then at 508 the order is expired. At 510, all payment authorizations from the contributors are cancelled. At 512, notification is sent to all contributors of the order expiration.

FIG. 6A illustrates an example system which may be employed in some embodiments of the invention, where the co-buy mechanism 620 is included in conjunction with an enterprise application 604. As disclosed above, the co-buy mechanism 620 provides a framework for automatically permitting a sales order to be collectively purchased by a group of customers.

The enterprise application 604 comprises any application having business logic for implementing marketing and/or sales activities e.g., to track marketing opportunities, perform price quotations, and/or generate order capture for customers. In some embodiments the enterprise application is a CRM application. For the purposes of illustration and explanation, the present disclosure is described in various embodiments in the context of CRM applications. It is noted, however, that the invention is not limited in its scope to CRM applications, and indeed, may be applied to other types of enterprise applications as well.

The system presents a sales interface to a user through a web application 622. The web application generates content that is displayable in a typical web browser, e.g., by providing Hyper Text Markup Language (HTML) content through web pages. The content or data present in each web page can be navigated by the end users using a Graphical User Interface (GUI).

The system includes one or more users at one or more user stations 602 that operate the system. The user station 602 comprises any type of computing station that may be used to operate or interface with the system. Examples of such user stations 602 include, for example, workstations, personal computers, or remote computing terminals. The user stations 602 may also be implemented as mobile devices, such as mobile telephones or tablet devices. The user station 602 comprises a display device, such as a display monitor, for displaying a user interface to users. The user station 602 also comprises one or more input devices for the user to provide operational control over the activities of the system, such as a mouse, touchpad or keyboard to manipulate a pointing object in a graphical user interface to generate user inputs.

The enterprise application 604 accesses a sales catalog that contains details about the products presented for sale by the system. The sales catalog 604 may be accessed, for example, by business logic in the enterprise application 604 to perform price quotations and/or capture orders 612 for customers. The data within the system can be stored into a database 616 in a computer readable storage device. The computer readable storage device comprises any combination of hardware and software that allows for ready access to the data that is located at the computer readable storage device. For example, the computer readable storage device could be implemented as computer memory operatively managed by an operating system. The computer readable storage device could also be implemented as an electronic database system having storage on persistent and/or non-persistent storage.

FIG. 6B shows an alternate approach to implement the system. This approach provides the co-buy mechanism 620 as a component of a shopping application 608 that is built to operate as a storefront on a social media system 606. As just one example, the social media system 606 can be the Facebook social media site. In this approach, the shopping application comprises a shop that is established, for example, as a storefront onto the Facebook shopping page for a business or a Facebook page that has been established for a marketing campaign for that business.

Any suitable approach can be taken to present the content of the shopping application 608 onto an interface for display to the user through social media system 606. One example approach is described in U.S. application Ser. No. 13/018,225, entitled “SYSTEMS AND METHODS FOR CREATING AND INSERTING APPLICATION MEDIA CONTENT INTO SOCIAL MEDIA SYSTEM DISPLAYS”, filed on Jan. 31, 2011, which is hereby incorporated by reference in its entirety.

In the approach of FIG. 6B, the shopping application 608 interfaces to the enterprise/CRM application 604 through the social media system 606. Alternatively, as shown in FIG. 6C, the shopping application 608 directly interfaces to the enterprise/CRM application 604, without going through the social media system 606.

FIG. 6D illustrates yet another approach, whereby the system does not utilize a separate enterprise/CRM application. Instead, the shopping application 608 itself contains sufficient logic to perform required order taking functionality. Therefore, the shopping application maintains and/or accesses database 616 to access the sales catalog 610 and to generate/store order data 612.

FIG. 7 illustrates an architecture 702 for the storefront shopping application 608 according to some embodiments of the invention. This architecture creates interface content for the shopping experience that is displayable through the social media site, e.g., by using an iframe to display the content.

Architecture 702 includes a shop module 702 having mechanisms to implement the shopping process for the user. This module 702 provides the shop infrastructure for the shopping application 608, presenting the user with the shopping interface pages for the store. In addition, module 702 accesses a sales catalog to search for and/or display product/services items for sale to the customer, e.g. by displaying product details to the customer. The shopping cart is also maintained by module 702, where selected purchase items are added to the cart, and unwanted items are removed from the cart.

The shop module 702 is configured to handle co-buy shopping experiences. Specifically, the shopping process includes options for the user to implement the purchase using the co-buy approach as described above. Therefore, the processing path for the shop module 702 comprises some or all of the actions/mechanisms described above.

Architecture 700 also includes a checkout module 704 to implement a checkout process for the store application 608. Any suitable checkout processing mechanism can be employed in architecture 700. In some embodiments, the checkout module comprises Spree checkout processing to handle checkout of items in the shopping cart. The checkout process may separately address checkout of hard goods versus checkout of soft goods.

The checkout process is configured to handle co-buy shopping experiences. Specifically, the checkout process includes options for the user to complete the purchase using the co-buy approach as described above. Therefore, the processing path for the checkout module 704 comprises some or all of the actions/mechanisms described above.

Payment processing is performed with module 706. This module identifies the specific payment method selected by the user. The module 706 will then interface with an external processing/authorization system to complete the payment process, e.g., by interfacing with Paypal, Authorize.net, and/or Braintree.

The order summary module 708 creates an order summary. The order summary comprises some or all of the pertinent details for the order. For example, for the co-buy shopping process, the order summary may include information about the purchase prices, identity of members of the shopping group, payment amount by members of the group, recipient information, and/or delivery information.

FIG. 8 illustrates an example architecture 800 for administrating the shopping application. The architecture 800 includes an authentication component 820. The authentication component provides a mechanism for implementing authentication functionality for acing and using the administration system. In some embodiments, a secure remote management appliance (SRMa) may be used to implement the authentication component 820.

Administration for the shopping application is provided by the administration module 802. The administration module 802 may be accessed through any suitable entry path. In some embodiments, the administration module 802 is accessed through other administrative consoles 818, e.g., for the console that generally administers additional content for the host social media website (e.g., using the Vitrue Tabs product available from Oracle Corporation of Redwood Shores, Calif.). Alternatively, the administration module 802 may be directly accessed without first traversing another administrative console.

A module setup component 816 may be employed to configure the administrative module 802. This component configures, for example, the identity of the persons that are authorized to access the administrative module 802 and to make administrative changes to the shopping application.

The administration module 802 comprises an overview component 804. The overview component is used to provide analytics for the application. The order component 808 is used to configure parameters for the ordering process at the shopping application. With respect to the co-buy purchasing process, this component 808 may be used to configure various parameters for allowing a group purchase to occur. For example, component 808 can be used to configure the exact timer period for the co-buy purchase, e.g., to set the expiration time period to 48 hours.

The catalog component 812 configures the catalog parameters for the shopping application. This component 812 is used, for example, to identify the specific sales catalog data to be accessed by the shopping application.

The promotions component 806 is used to configure the parameters of any marketing promotions to be displayed at and/or used by the shopping application. Such promotions include, for example, coupons, discount codes, and other such marketing activities.

The configuration component 810 is employed to administratively configure various options within the shopping application. The design component 814 permits administrative changes to be made to the design of the shopping application, e.g., to the layout of the shopping page, to select images that are displayed, and to select other items of multimedia to present.

Therefore, what has been described is an improved approach to implement a shopping interface. The co-buy mechanism of the present invention permits any purchase decision by a consumer to be implemented as a group purchase. The co-buy mechanism provides functionality to automatically implement sharing of the purchase prices by the participants to the group purchase.

This approach provides significant advantages over existing shopping systems. While conventional shopping systems require one of the purchasers to individually order and pay for the item upfront to complete the purchase, the present invention permits the purchase to be made and completed by multiple participants. This removes any disincentives that exist in conventional to such group purchases. In addition, this approach permits sales to be made even if each member of the group does not individually on his/her own have the financial means to make the purchase.

### System Architecture Overview

FIG. 9 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. Data may be stored in a database 1432 on a storage medium 1431 which is accessed through data interface 1433.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A computer implemented method implemented with a processor for co-buy, comprising:
receiving an instruction to implement co-buy purchase for an order on a shopping system, wherein the co-buy purchase corresponds to a purchase order that is collectively made by a plurality of consumers;
identifying multiple participants for the co-buy purchase, wherein an invitation is sent to the multiple participants for the co-buy purchase;
determining whether buying conditions for the co-buy purchase is satisfied, determined at least in part by checking for responses from the multiple participants that agree or refuse to participate in the co-buy purchase; and
completing the co-buy purchase if the buying conditions are satisfied, wherein payment is automatically made by the participants in the co-buy purchase.

2. The method of claim 1, in which the co-buy purchase is presented on a storefront on a social media site.

3. The method of claim 1, in which a time period is set for expiration of the co-buy purchase.

4. The method of claim 1, in which payment authorizations are obtained from a participant when agreement is made to participate.

5. The method of claim 1, wherein an invited participant further invites other possible participants.

6. The method of claim 1, in which an overall purchase price is equally split among the participants.

7. The method of claim 1, in which the participants configure at least one of a specific payment amount, a minimum payment amount, and a maximum payment amount.

8. The method of claim 1, wherein the co-buy purchase is configured to have at one of an option to create a note if desired, add a contributors, remove a contributor, show an estimated price, show contributor amounts, and configure a timer.

9. A computer program product embodied on a computer usable medium, the computer readable medium having stored thereon a sequence of instructions which, when executed by a processor causes the processor to execute a method for implementing a co-buy purchase, the method comprising:
receiving an instruction to implement co-buy purchase for an order on a shopping system, wherein the co-buy purchase corresponds to a purchase order that is collectively made by a plurality of consumers;
identifying multiple participants for the co-buy purchase, wherein an invitation is sent to the multiple participants for the co-buy purchase;
determining whether buying conditions for the co-buy purchase is satisfied, determined at least in part by checking for responses from the multiple participants that agree or refuse to participate in the co-buy purchase; and
completing the co-buy purchase if the buying conditions are satisfied, wherein payment is automatically made by the participants in the co-buy purchase.

10. The computer program product of claim 9, in which the co-buy purchase is presented on a storefront on a social media site.

11. The computer program product of claim 9, in which a time period is set for expiration of the co-buy purchase.

12. The computer program product of claim 9, in which payment authorizations are obtained from a participant when agreement is made to participate.

13. The computer program product of claim 9, wherein an invited participant further invites other possible participants.

14. The computer program product of claim 9, in which an overall purchase price is equally split among the participants.

15. The computer program product of claim 9, in which the participants configure at least one of a specific payment amount, a minimum payment amount, and a maximum payment amount.

16. The computer program product of claim 9, wherein the co-buy purchase is configured to have at one of an option to create a note if desired, add a contributors, remove a contributor, show an estimated price, show contributor amounts, and configure a timer.

17. A system for implementing a co-buy purchase, comprising:
a processor;
a co-buy purchase mechanism comprising computer code executed using the processor, in which the computer code implements a co-buy purchase for an order on a shopping system, wherein the co-buy purchase corresponds to a purchase order that is collectively made by a plurality of consumers.

18. The system of claim 17, in which the co-buy purchase mechanism is located at a storefront for a social media site or within an enterprise application.

19. The system of claim 18, in which the enterprise application comprises a CRM application.

20. The system of claim 17, in which the co-buy purchase mechanism accesses a sales catalog to present item information to a consumer, and generates order data for an order database.

21. The system of claim 17, in which the computer code executed using the processor implements identifying multiple participants for the co-buy purchase, wherein an invitation is sent to the multiple participants for the co-buy purchase, determining whether buying conditions for the co-buy purchase is satisfied, determined at least in part by checking for responses from the multiple participants that agree or refuse to participate in the co-buy purchase, and completing the co-buy purchase if the buying conditions are satisfied, wherein payment is automatically made by the participants in the co-buy purchase.

22. The system of claim 17, further comprising a timer that is set for expiration of the co-buy purchase.

23. The system of claim 17, further comprising a payment component to obtain authorizations from a participant when agreement is made to participate.

24. The system of claim 17, further comprising a component that permits an invited participant further invites other possible participants.

25. The system of claim 17, further comprising a configuration parameter that sets at least one of a specific payment amount, a minimum payment amount, and a maximum payment amount for the co-buy purchase.

26. The system of claim 17, further comprising an administrative module to administer the co-buy purchase.

27. The system of claim 26, in which the administrative module comprises at least one of an overview component, an orders component, a catalog component, a promotions component, a configuration component, and a design component.

28. The system of claim 17, in which the co-buy purchase mechanism comprises a shopping component, a checkout component, a payment component, and a component to generate an order summary.
